(19) United States
(12) Patent Application Publication
(10) Pub. No.: US 2020/0395822 A1
(43) Pub. Date: Dec. 17, 2020

(54) STATOR AND THERMISTOR UNIT

(71) Applicant: HONDA MOTOR CO., LTD., Tokyo (JP)

(72) Inventors: Nobuaki Hayashi, Wako-shi (JP); Shin Aoki, Wako-shi (JP)

(21) Appl. No.: 16/896,335

(22) Filed: Jun. 9, 2020

(30) Foreign Application Priority Data
Jun. 12, 2019 (JP) 2019-109361

(51) Int. Cl. H02K 11/25; H02K 1/12; H01C 7/00

(52) U.S. Cl. CPC H02K 11/25; H01C 7/008; H02K 1/12

(57) ABSTRACT

Provided are a stator and a thermistor unit in which a thermistor can be easily attached while the number of parts is reduced. The stator includes a stator core 2 which is formed in an annular shape and has an attachment hole 21 recessed in the axial direction, a coil 3 which is mounted on the stator core 2 and partly protrudes from an end surface of the stator core 2 in an axial direction thereof, and a thermistor unit 4 which is partly inserted into the attachment hole 21 and fixed to the stator core 2. The thermistor unit 4 includes a thermistor 6 measuring a temperature of the coil 3, and a support body 5 supporting the thermistor 6. The support 5 body has a main body portion 51 holding the thermistor 6 to be in contact with the coil 3, a leg portion 52 which has elasticity, extends from the main body portion 51, and is inserted into the attachment hole 21, and an engagement portion 54 which is provided in the leg portion 52 and engages with the stator core 2.

### CROSS-REFERENCE TO RELATED APPLICATION

Priority is claimed on Japanese Patent Application No. 2019-109361, filed Jun. 12, 2019, the content of which is incorporated herein by reference.

### BACKGROUND OF THE INVENTION

### Field of the Invention

The present invention relates to a stator and a thermistor unit.

### Description of Related Art

Conventionally, a configuration in which a rotating electrical machine used in an electric vehicle, a hybrid vehicle, or the like has a stator around which a coil is wound is known. A thermistor for measuring and managing a temperature of the coil may be used in the rotating electrical machine in order to inhibit deterioration in performance of the rotating electrical machine when the temperature of the coil rises and exceeds a predetermined value. For this reason, various techniques have been proposed for attaching a thermistor to a coil to measure a temperature of the coil.

For example, Japanese Unexamined Patent Application, First Publication No. 2013-51806 (Patent Document 1) discloses a configuration of a stator having a stator core, a coil end protruding from the stator core, a resin thermistor holder which holds a thermistor, and a bracket which is fixed to a casing and supports the thermistor holder to bring the thermistor into contact with a coil. According to the technique disclosed in Patent Document 1, a metal arm provided on the bracket presses the thermistor against an outer surface of the coil end, whereby a temperature of the outer surface of the coil end can be stably detected.

### SUMMARY OF THE INVENTION

However, in the technique disclosed in Patent Document 1, since it is necessary to provide the bracket in addition to the thermistor holder that holds the thermistor, the number of parts may increase. Further, since a process of fastening the bracket and the casing together with bolts with the thermistor pressed with the bracket is required, the work may be complicated.

Therefore, an object of the present invention is to provide a stator and a thermistor unit in which a thermistor can be easily attached while the number of parts is reduced.

A stator and a thermistor unit according to the present invention employ the following configurations.

(1) A stator (for example, a stator 1 in a first embodiment) according to an aspect of the present invention includes a stator core (for example, a stator core 2 in the first embodiment) which is formed in an annular shape and has an attachment hole (for example, an attachment hole 21 in the first embodiment) recessed in an axial direction, a coil (for example, a coil 3 in the first embodiment) which is mounted on the stator core and partly protrudes from an end surface of the stator core in the axial direction, and a thermistor unit (for example, a thermistor unit 4 in the first embodiment) which is partly inserted into the attachment hole and fixed to the stator core. The thermistor unit includes a thermistor measuring a temperature of the coil (for example, a thermistor 6 in the first embodiment), and a support body supporting the thermistor (for example, a support body 5 in the first embodiment). The support body includes a main body portion (for example, a main body portion 51 in the first embodiment) which holds the thermistor to be in contact with the coil, a leg portion (for example, a leg portion 52 in the first embodiment) which has elasticity, extends from the main body portion and is inserted into the attachment hole, and an engagement portion (for example, an engagement portion 54 in the first embodiment) which is provided in the leg portion and engages with the stator core.

(2) In the aspect of the above-mentioned (1), the attachment hole may be formed to be inclined with respect to a protruding direction of the coil from an inner side toward an outer side in a radial direction of the stator core while going from an inner side toward an outer side in the axial direction.

(3) In the aspect of the above-mentioned (1) or (2), the engagement portion may be provided at a tip of the leg portion (for example, a tip 53 in the first embodiment).

(4) In the aspect of any one of the above-mentioned (1) to (3), a pair of the leg portions may be provided side by side, a pair of the engagement portions may be provided to protrude in directions in which the pair of leg portions are separated from each other, and a length between outermost portions of the pair of engagement portions (for example, a length L1 between outermost portions in the first embodiment) may be larger than an outermost width length (for example, an outermost width length L2 in the first embodiment) of the attachment hole in a circumferential direction of the stator core.

(5) In the aspect of any one of the above-mentioned (1) to (4), the support body may be made of a resin material.

(6) A thermistor unit (for example, the thermistor unit 4 in the first embodiment) according to an aspect of the present invention is a thermistor unit configured to measure a temperature of a measurement target (for example, the coil 3 in the first embodiment) by bringing a thermistor (for example, a thermistor 6 in the first embodiment) into contact with the measurement target. The thermistor unit includes a thermistor measuring the temperature of the measurement target, a main body portion (for example, the main body portion 51 in the first embodiment) which holds the thermistor to be in contact with the measurement target, a leg portion (for example, the leg portion 52 in the first embodiment) which has elasticity, extends from the main body portion and is inserted into an attachment hole (for example, the attachment hole 21 in the first embodiment) provided to be inclined with respect to the measurement target, and an engagement portion (for example, the engagement portion 54 in the first embodiment) which is provided in the leg portion and engages with the attachment hole.

(7) In the aspect of any one of the above-mentioned (6), the engagement portion may be provided at a tip of the leg portion (for example, the tip 53 in the first embodiment).

(8) In the aspect of the above-mentioned (6) or (7), a pair of the leg portions may be provided side by side, a pair of the engagement portions may be provided to protrude in directions in which the pair of leg portions are separated from each other, and a length between outermost portions of the pair of engagement portions may be larger than an outermost width length of the attachment hole in an arrangement direction of the leg portions.

According to the configuration of (1), the support body of the thermistor unit has the main body portion holding the thermistor, the leg portion extending from the main body portion, and the engagement portion provided in the leg portion, and thermistor can be brought into contact with the coil by inserting the leg portion into the attachment hole of the stator core. Since the leg portion is provided with the engagement portion, the thermistor unit is fixed to the stator core by engaging the engagement portion with the stator core. In this way, the thermistor unit can be attached to the stator core and the thermistor can be held in contact with the coil simply by inserting the leg portion into the attachment hole. Therefore, workability at the time of attaching the thermistor can be improved as compared with the conventional technique in which the thermistor unit is fixed to the stator using a fastener such as a bolt. Since the thermistor unit can be attached directly to the stator core, parts such as a bracket for supporting the thermistor unit are unnecessary, and thus the number of parts can be reduced. As a result, costs for attaching the thermistor can be reduced.

Therefore, it is possible to provide the stator in which the thermistor can be easily attached while the number of parts is reduced.

According to the configuration of (2), the attachment hole is inclined with respect to the protruding direction of the coil from the inner side toward the outer side in the radial direction while going from the inner side toward the outer side in the axial direction. Thus, the thermistor can be brought into contact with a radially outer side surface of the coil by inserting the leg portion along the attachment hole. Since the leg portion becomes closer to the coil side in the radial direction as an insertion depth thereof into the attachment hole increases, a component force of a force along the inserting direction of the leg portion can be used as a pressing force on the coil side of the thermistor. Therefore, the pressing force for pressing the thermistor against the coil can be secured, and holding strength of the thermistor can be improved. Thus, the temperature of the coil can be stably and accurately measured.

According to the configuration of (3), since the engagement portion is provided at the tip of the leg portion, a length of the leg portion from the main body portion to the engagement portion can be increased. Thus, for example, since a deformation amount of a connection portion between the leg portion and the main body portion and a deformation amount per unit length of the leg portion are reduced when a force is applied to the engagement portion and the leg portion is elastically deformed, occurrence of excessive stress in the leg portion can be inhibited. Since the leg portion can be bent with a small moment, a force required at the time of inserting the leg portion into the attachment hole can be reduced. Therefore, the thermistor unit can be easily attached to the stator core.

According to the configuration of (4), the pair of leg portions are provided side by side, and the pair of engagement portions are provided to protrude in the directions in which the pair of leg portions are separated from each other. Thus, when the leg portions are inserted into the attachment hole, the pair of engagement portions and the leg portions are inserted into the attachment hole in a state in which they are compressed to be closer to each other. Here, since the leg portions have elasticity, the engagement portions engage with an inner wall of the attachment hole due to a restoring force for the pair of leg portions to return in the directions in which they separate from each other inside the attachment hole. Thus, the leg portion can be securely attached to the stator core.

The length between the outermost portions of the pair of engagement portions is larger than the outermost width length in the circumferential direction of the attachment hole. Thus, by inserting the leg portion provided with the engagement portion into the attachment hole, the leg portion is elastically deformed and the engagement portion engages with the attachment hole. Therefore, attachment of the leg portion can be facilitated, and thus the thermistor unit can be easily attached to the stator core.

According to the configuration of (5), since the support body is made of a resin material, the elastic leg portion can be easily formed.

According to the configuration of (6), the thermistor, the main body portion that holds the thermistor, the leg portion that extends from the main body portion, and the engagement portion provided in the leg portion are provided, and the thermistor can be brought into contact with the measurement target by inserting the leg portion into the attachment hole. Since the leg portion is provided with the engagement portion, the thermistor unit is fixed by engaging the engagement portion with the attachment hole. In this way, the thermistor unit can be attached and the thermistor can be held in contact with the measurement target simply by inserting the leg portion into the attachment hole. Therefore, as compared with the case in which the thermistor unit is fixed by using a fastener such as a bolt, workability at the time of mounting the thermistor can be improved. Since the thermistor unit can be attached simply by inserting the thermistor unit into the attachment hole, parts such as a bracket for supporting the thermistor unit are unnecessary, and thus the number of parts can be reduced. As a result, costs for attaching the thermistor can be reduced.

Therefore, it is possible to provide the thermistor unit in which the thermistor can be easily attached while the number of parts is reduced.

Since the attachment hole is inclined with respect to the measurement target, the thermistor can be brought into contact with the radially outer side surface of the coil by inserting the leg portion along the attachment hole. Since the attachment hole and the measurement target are inclined with respect to each other, a component force of the force in the insertion direction of the leg portion can be used as the pressing force of the thermistor toward the measurement target. Therefore, the pressing force for pressing the thermistor against the coil can be secured, and the holding strength of the thermistor can be improved. Thus, the temperature of the measurement target can be stably and accurately measured.

According to the configuration of (7), since the engagement portion is provided at the tip of the leg portion, the length between the main body portion and the engagement portion can be increased. Thus, for example, when a force acts on the engagement portion and the leg portion is elastically deformed, occurrence of an excessive load in the leg portion can be inhibited. Since the force required at the time of inserting the leg portion into the attachment hole can be reduced, the thermistor unit can be easily mounted.

According to the configuration of (8), the pair of leg portions are provided side by side, and the pair of engagement portions are provided to protrude in the directions in which the pair of leg portions are separated from each other. Thus, when the leg portion is inserted into the attachment hole, the pair of engagement portions and the leg portions are inserted into the attachment hole in a state in which they are compressed to be closer to each other. Here, since the leg portion is formed of an elastic member, the engagement portions engage with the inner wall of the attachment hole due to the restoring force for the pair of leg portions to return in the direction in which they separate from each other inside the attachment hole. Thus, the leg portion can be securely attached to the attachment hole.

A distance between the outermost portions of the pair of engagement portions is larger than the outermost width length of the attachment hole in the direction in which the leg portions are arranged. Thus, by inserting the leg portions provided with the engagement portions into the attachment hole, the leg portions are elastically deformed and the engagement portions engage with the attachment hole. Therefore, the leg portions can be easily attached, and thus the thermistor unit can be easily attached.

### BRIEF DESCRIPTION OF THE DRAWINGS

FIG. 1 is a front view of a stator according to a first embodiment.

FIG. 2 is a cross-sectional view taken along line II-II in FIG. 1.

FIG. 3 is a front view of a thermistor unit according to the first embodiment.

FIG. 4 is a front view of a thermistor unit according to a modified example of the first embodiment.

FIG. 5 is a front view of a stator according to a second embodiment.

FIG. 6 is a cross-sectional view of a stator according to a third embodiment.

### DETAILED DESCRIPTION OF THE INVENTION

Hereinafter, embodiments of the present invention will be described with reference to the drawings.

### First Embodiment

[Stator]

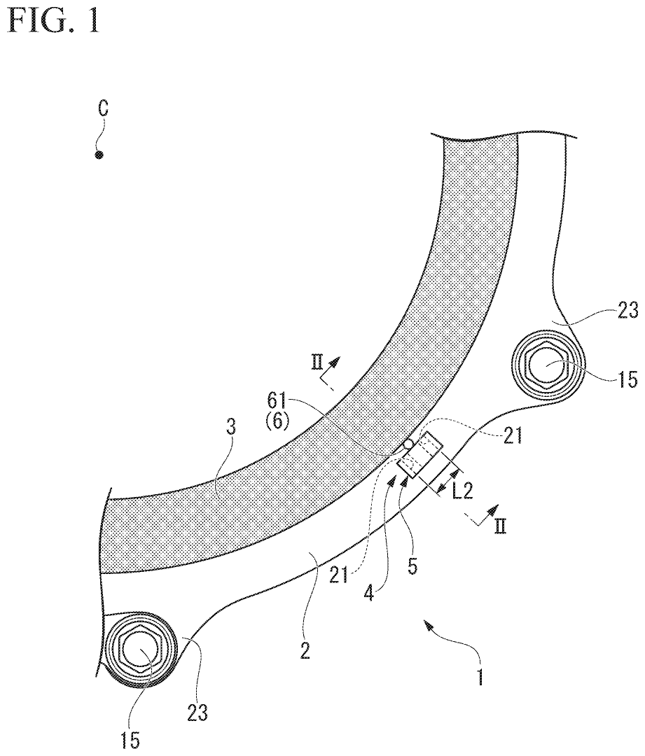

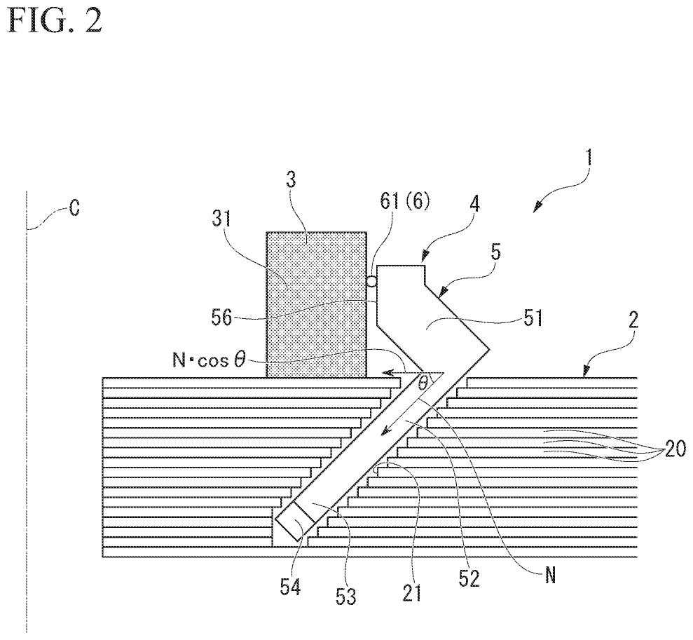

FIG. 1 is a front view of a stator 1 according to a first embodiment. FIG. 2 is a cross-sectional view taken along line II-II in FIG. 1. FIG. 1 illustrates part of the stator 1.

The stator 1 is the stator 1 of a traction motor mounted on a vehicle such as a hybrid vehicle or an electric vehicle. However, the configuration of the present invention is not limited to a traction motor and can be applied as the stator 1 to a power generation motor, motors for other purposes, and rotating electrical machines (including power generation machines) other than a vehicle.

The stator 1 is formed in an annular shape around an axis C. In the following description, a direction along the axis C of the stator 1 may be simply referred to as an axial direction, a direction orthogonal to the axis C may be referred to as a radial direction, and a direction around the axis C may be referred to as a circumferential direction. A rotor (not shown) is disposed inside the stator 1 in the radial direction. The rotor is rotatable about the axis C with respect to the stator 1. The stator 1 includes a stator core 2, a coil 3 (a measurement target in the claims), and a thermistor unit 4.

The stator core 2 is formed in an annular shape around the axis C. The stator core 2 is formed by stacking a plurality of steel plate pieces 20 (see FIG. 2) in a thickness direction thereof. With the plurality of steel plate pieces 20 stacked in the thickness direction, the plurality of steel plate pieces 20 are fixed by inserting bolts 15 into bolt fastening portions 23 formed to protrude outward from the respective steel plate pieces 20 in the radial direction. The stator core 2 has a plurality of teeth (not shown) protruding inward in the radial direction. The plurality of teeth are formed in the circumferential direction. Attachment holes 21 are provided between the bolt fastening portions 23 and the teeth in the radial direction. The attachment holes 21 are formed in rectangular shapes when viewed in the axial direction and are recessed in the axial direction. A pair of attachment holes 21 are provided side by side in the circumferential direction. Each of the pair of attachment holes 21 has the same configuration. As shown in FIG. 2, in the present embodiment, the attachment hole 21 is inclined from an inner side toward an outer side in the radial direction of the stator core 2 while going from an inner side toward an outer side in the axial direction. The attachment hole 21 is inclined at an angle θ with respect to an end surface of the stator core 2 when viewed in the radial direction.

The coil 3 is mounted on the stator core 2 by being wound around the teeth of the stator core 2. Part of the coil 3 is a coil end 31 that protrudes outward in the axial direction from both axial end surfaces of the stator core 2.

[Thermistor Unit]

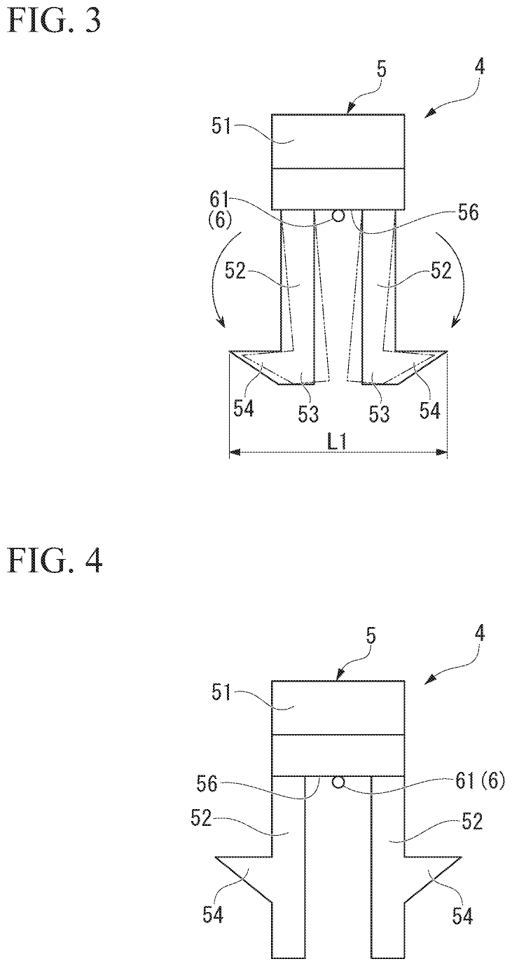

FIG. 3 is a front view of the thermistor unit 4 according to the first embodiment.

The thermistor unit 4 is a component attached to the stator 1 to measure a temperature of the coil 3. As shown in FIGS. 2 and 3, the thermistor unit 4 has a support body 5 and a thermistor 6.

The support body 5 is made of a resin material. The support body 5 has a main body portion 51, leg portions 52, and engagement portions 54.

The main body portion 51 is disposed outside the coil end 31 in the axial direction. The main body portion 51 is located outside the end surface of the stator core 2 in the axial direction. The main body portion 51 has a pressing surface 56 that faces a side surface of the coil end 31.

The leg portions 52 are connected to the main body portion 51. The leg portions 52 extend outward from the main body portion 51. A pair of leg portions 52 are provided side by side from the main body portion 51. The leg portions 52 are elastically deformable in directions in which the pair of leg portions 52 come closer to and separate from each other. The pair of leg portions 52 are inserted into a corresponding pair of attachment holes 21, respectively. In a state in which the support body 5 is attached to the stator core 2, the pair of leg portions 52 are disposed such that an aligning direction of the pair of leg portions 52 is in the circumferential direction of the stator core 2.

The engagement portions 54 are provided at tips 53 of the leg portions 52. A pair of engagement portions 54 are provided to protrude in directions in which the pair of leg portions 52 are separated from each other. In a state before the leg portions 52 are elastically deformed, a length L1 between outermost portions of the pair of engagement portions 54 is larger than an outermost width length L2 (see FIG. 1) in the circumferential direction of the attachment hole 21. Thus, the pair of engagement portions 54 are inserted into the attachment hole 21 in a state in which the leg portions 52 are elastically deformed in directions in which the engagement portions 54 come closer to each other. The engagement portions 54 engage with the stator core 2 due to a restoring force of the leg portions 52 in the attachment hole 21, which have a tendency to return in the direction in which they separate from each other. Specifically, in the attachment hole 21, the engagement portions 54 are hooked on stepped portions formed by the plurality of stacked steel plate pieces 20. As a result, movement of the leg portions 52 in a pull-out direction is restricted.

The thermistor 6 is supported by the support body 5. The thermistor 6 is a contact-type temperature sensor that measures the temperature of the coil 3 by bringing a temperature detection portion 61 into contact with a surface of the coil 3. In the present embodiment, the thermistor 6 measures the temperature of the coil end 31. As shown in FIG. 2, the temperature detection portion 61 of the thermistor 6 is disposed between the pressing surface 56 of the support body 5 and the coil end 31. The temperature detection portion 61 is pressed by the main body portion 51 toward the coil end 31 side. Thus, the temperature detection portion 61 is held in contact with the side surface of the coil end 31. The temperature detection portion 61 is connected to a control unit via a wire (both are not shown). Also, part of the wire may be integrally formed with the support body 5 by insert molding, for example.

(Method of Setting Inclination Angle θ)

Next, a method of setting the inclination angle θ of the attachment hole 21 will be described.

As shown in FIG. 2, the attachment hole 21 is formed to be inclined at the angle θ with respect to a protruding direction (parallel to the axial direction in the present embodiment) of the coil end 31 from the inner side toward the outer side in the radial direction of the stator core while going from the inner side toward the outer side in the axial direction. When an insertion load of the support body 5 in an insertion direction of the attachment hole 21 is defined as N, a pressing force (a component force in the radial direction) by which the thermistor 6 perpendicularly presses the side surface of the coil end 31 is a value of N·cos θ. A value of θ is preferably set to cause the value of N·cos θ to be equal to or more than a set value X of the pressing force of the thermistor 6 against the coil end 31. That is, the value of θ is preferably set to satisfy θ≤arccos (X/N).

[Operations and Effects]

Next, operations and effects of the stator 1 and the thermistor unit 4 will be described.

According to the stator 1 of the present embodiment, the support body 5 of the thermistor unit 4 has the main body portion 51 for holding the thermistor 6, the leg portions 52 extending from the main body portion 51, and the engagement portions 54 provided in the leg portions 52, and the thermistor 6 can be brought into contact with the coil 3 by inserting the leg portions 52 into the attachment hole 21 of the stator core 2.

Since the leg portions 52 are provided with the engagement portions 54, the thermistor unit 4 is fixed to the stator core 2 by engaging the engagement portions 54 with the stator core 2. In this way, simply by inserting the leg portions 52 into the attachment hole 21, the thermistor unit 4 can be attached to the stator core 2 and the thermistor 6 can be held in contact with the coil 3. Therefore, as compared with conventional techniques in which the thermistor unit 4 is fixed to the stator 1 by using a fastener such as a bolt, workability at the time of attaching the thermistor 6 can be improved. Since the thermistor unit 4 can be directly attached to the stator core 2, parts such as a bracket for supporting the thermistor unit 4 are unnecessary, and thus the number of parts can be reduced. As a result, costs for attaching the thermistor 6 can be reduced.

Therefore, it is possible to provide the stator 1 in which the thermistor 6 can be easily attached while the number of parts is reduced.

The attachment hole 21 is inclined with respect to the protruding direction of the coil 3 from the inner side toward the outer side in the radial direction while going from the inner side toward the outer side in the axial direction. Thus, by inserting the leg portions 52 along the attachment hole 21, the thermistor 6 can be brought into contact with a radially outer side surface of the coil 3. Since the leg portions 52 become closer to the coil 3 side in the radial direction as an insertion depth thereof into the attachment hole 21 is increased, the component force of the force in the insertion direction of the leg portions 52 can be used as the pressing force of the thermistor 6 toward the coil 3. Therefore, the pressing force for pressing the thermistor 6 against the coil 3 can be secured, and holding strength of the thermistor 6 can be improved. As a result, the temperature of the coil 3 can be stably and accurately measured.

Since the engagement portions 54 are provided at the tips 53 of the leg portions 52, a length of the leg portion 52 from the main body portion 51 to the engagement portions 54 can be increased. Thus, for example, since a deformation amount of a connection portion between the leg portions 52 and the main body portion 51 and a deformation amount per unit length of the leg portion 52 become smaller when forces acts on the engagement portions 54 and the leg portions 52 elastically deform, occurrence of excessive stresses in the leg portions 52 can be inhibited. Since the leg portions 52 can be bent with a small moment, a force required at the time of inserting the leg portions 52 into the attachment hole 21 can be reduced. Therefore, attachment of the thermistor unit 4 to the stator core 2 can be easily performed.

The pair of leg portions 52 are provided side by side, and the pair of engagement portions 54 are provided to protrude in the direction in which the pair of leg portions 52 are separated from each other. Thus, when the leg portion 52 are inserted into the attachment hole 21, the pair of engagement portions 54 and the leg portion 52 are inserted into the attachment hole 21 in a state in which they are compressed to come closer to each other. Here, since the leg portion 52 has elasticity, the engagement portions 54 engage with an inner wall of the attachment hole 21 due to the restoring force for the pair of leg portions 52 to return in the directions in which they separate from each other inside the attachment hole 21. As a result, the leg portions 52 can be securely attached to the stator core 2.

The length L1 between the outermost portions of the pair of engagement portions 54 is larger than the outermost width length L2 in the circumferential direction of the attachment hole 21. Thus, by inserting the leg portions 52 provided with the engagement portions 54 into the attachment hole 21, the leg portions 52 elastically deforms and the engagement portions 54 engage with the attachment hole 21. Therefore, the leg portions 52 can be easily attached, and thus the thermistor unit 4 can be easily attached to the stator core 2.

Since the support body 5 is made of a resin material, the leg portions 52 having elasticity can be easily formed.

According to the thermistor unit 4 of the present embodiment, the thermistor 6, the main body portion 51 holding the thermistor 6, the leg portions 52 extending from the main body portion 51, and the engagement portions 54 provided in the leg portions 52 are provided, and the thermistor 6 can be brought into contact with the measurement target by inserting the leg portions 52 into the attachment hole 21. Since the leg portions 52 are provided with the engagement portions 54, the thermistor unit 4 is fixed by engaging the engagement portions 54 with the attachment hole 21. In this way, simply by inserting the leg portions 52 into the attachment hole 21, the thermistor unit 4 can be attached and the thermistor 6 can be held in contact with the measurement target. Therefore, as compared with the case in which the thermistor unit 4 is fixed using a fastener such as a bolt, workability at the time of attaching the thermistor 6 can be improved. Since the thermistor unit 4 can be attached simply by inserting the thermistor unit 4 into the attachment hole 21, parts such as a bracket for supporting the thermistor unit 4 are not required, and thus the number of parts can be reduced. As a result, costs for attaching the thermistor 6 can be reduced.

Therefore, it is possible to provide the thermistor unit 4 in which the thermistor 6 can be easily attached while the number of parts is reduced.

Since the attachment hole 21 is provided to be inclined with respect to the measurement target, the thermistor 6 can be brought into contact with the radially outer side surface of the coil 3 by inserting the leg portions 52 along the attachment hole 21. Since the attachment hole 21 and the measurement target are inclined with respect to each other, the component force of the force along the insertion direction of the leg portions 52 can be used as the pressing force of the thermistor 6 toward the measurement target. Therefore, the pressing force for pressing the thermistor 6 against the coil 3 can be secured, and the holding strength of the thermistor 6 can be improved. As a result, the temperature of the measurement target can be stably and accurately measured.

Since the engagement portions 54 are provided at the tips 53 of the leg portions 52, the length between the main body portion 51 and the engagement portions 54 can be increased. Thus, for example, when forces act on the engagement portions 54 and the leg portions 52 are elastically deformed, occurrence of an excessive load in the leg portions 52 can be inhibited. Since the force required at the time of inserting the leg portions 52 into the attachment hole 21 can be reduced, attachment of the thermistor unit 4 can be easily performed.

The pair of leg portions 52 are provided side by side, and the pair of engagement portions 54 are provided to protrude in the directions in which the pair of leg portions 52 are separated from each other. Thus, when the leg portions 52 are inserted into the attachment hole 21, the pair of engagement portions 54 and the leg portions 52 are inserted into the attachment hole 21 in the state in which they are compressed to come closer to each other. Here, since the leg portion 52 is formed of an elastic member, the engagement portions 54 engage with the inner wall of the attachment hole 21 due to the restoring force for the pair of leg portions 52 to return in the directions in which they separate from each other inside the attachment hole 21. As a result, the leg portions 52 can be securely attached to the attachment hole 21.

The distance L1between the outermost portions of the pair of engagement portions 54 is larger than the outermost width length L2 of the attachment hole 21 in the direction in which the leg portions 52 are arranged. Thus, by inserting the leg portions 52 provided with the engagement portions 54 into the attachment hole 21, the leg portions 52 elastically deform and the engagement portions 54 engage with the attachment hole 21. Therefore, attachment of the leg portions 52 can be facilitated, and thus attachment of the thermistor unit 4 can be easily performed.

[Modified Example of the First Embodiment]

Next, a modified example of the first embodiment according to the present invention will be described. FIG. 4 is a front view of a thermistor unit 4 according to the modified example of the first embodiment. The present embodiment is different from the first embodiment described above in that the engagement portions 54 are provided on the main body portion 51 side as compared with the aforementioned embodiment.

In the present embodiment, the engagement portions 54 are provided in middle portions of the leg portions 52 in longitudinal directions thereof. The pair of engagement portions 54 are provided to protrude in the directions in which the pair of leg portions 52 are separated from each other.

According to the present embodiment, as compared to the case in which the engagement portions 54 are provided at the tips 53 of the leg portions 52 as in the first embodiment, lengths of the leg portions 52 between the engagement portions 54 and the main body portion 51 are shortened. As a result, when the leg portions 52 are inserted into the attachment hole 21, the restoring force with which the engagement portions 54 try to return in the directions in which they are separated from each other increases, the engagement portions 54 can securely engage with the stator core 2.

### Second Embodiment

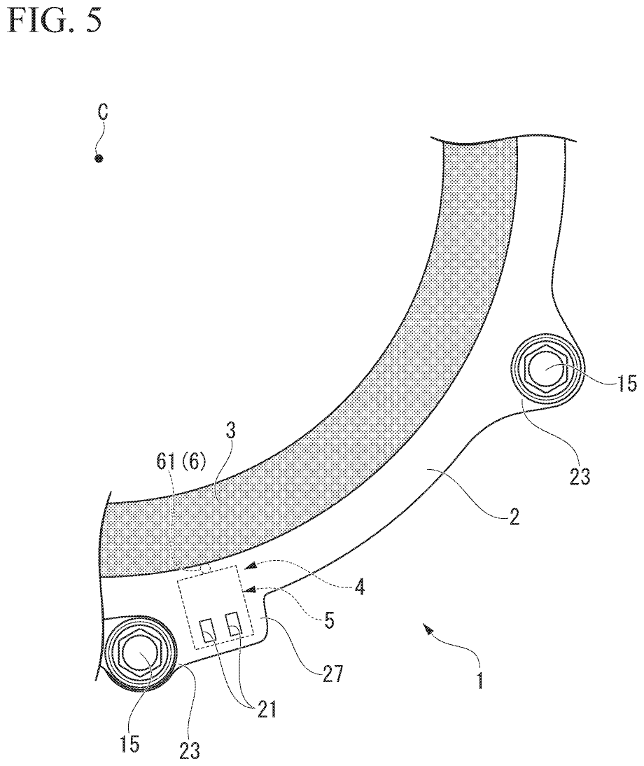

Next, a second embodiment according to the present invention will be described. FIG. 5 is a front view of a stator 1 according to the second embodiment. The present embodiment is different from the first embodiment described above in that, as compared with the first embodiment in which the attachment hole 21 is provided in a back yoke portion of the stator core 2, the attachment hole 21 is provided on an outer side thereof in the radial direction.

In the present embodiment, the stator core 2 has a protruding portion 27. The protruding portion 27 protrudes outward in the radial direction. The protruding portion 27 is provided at the same position as the bolt fastening portion 23 in the radial direction. The protruding portion 27 is connected to the bolt fastening portion 23 in the circumferential direction. The attachment hole 21 is formed in the protruding portion 27. A configuration of the attachment hole 21 is similar to that of the first embodiment described above.

According to the present embodiment, since the attachment hole 21 is formed in the protruding portion 27, the attachment hole 21 can be provided while avoiding the back yoke portion of the stator core 2 in which a magnetic path is formed. Thus, deterioration in motor performance due to the attachment hole 21 blocking the magnetic path can be inhibited. Since the protruding portion 27 is connected to the bolt fastening portion 23 in the circumferential direction, rigidity of the protruding portion 27 can be enhanced. Therefore, the thermistor unit 4 can be securely attached to the stator core 2.

### Third Embodiment

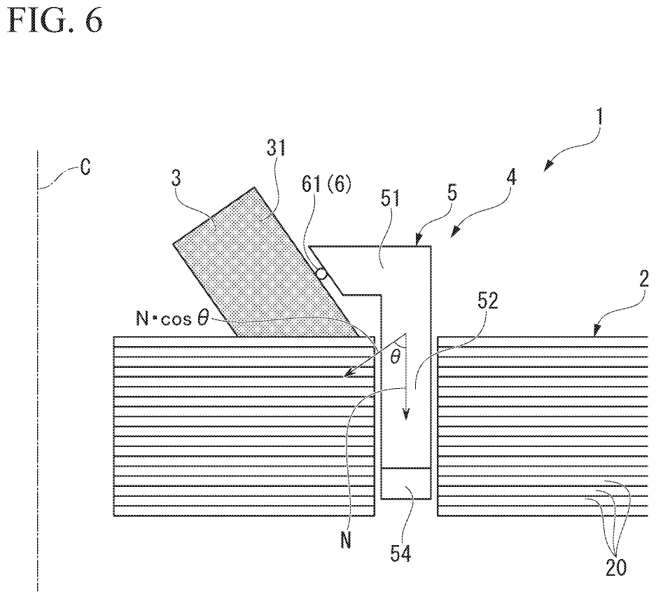

Next, a third embodiment according to the present invention will be described. FIG. 6 is a cross-sectional view of a stator 1 according to the third embodiment. The present embodiment is different from the first embodiment described above in that the attachment hole 21 is provided parallel to the axial direction.

In the present embodiment, the coil end 31 protrudes to be inclined from the outer side toward the inner side in the radial direction while going from a base end portion thereof located on the stator core 2 side toward a tip portion thereof. The stator core 2 has the attachment hole 21 that is recessed in the axial direction. The attachment hole 21 is formed such that a depth direction thereof is parallel to the axis C. The attachment hole 21 is formed to be inclined with respect to the protruding direction of the coil end 31 from the inner side toward the outer side in the radial direction of the stator core 2 while going from the inner side toward the outer side in the axial direction. The leg portions 52 of the support body 5 are inserted into the attachment hole 21. The pressing surface 56 provided on the main body portion 51 of the support body 5 faces the coil end 31.

According to the present embodiment, even when the coil end 31 is provided to be inclined with respect to the axial direction of the stator core 2, the attachment hole 21 is formed to be inclined with respect to the protruding direction of the coil end 31, and thus the same operation and effect as those of the first embodiment described above can be obtained. In addition, since the attachment hole 21 extends substantially parallel to the axis C, the attachment hole 21 formed in the steel plate 20 can have the same shape and position. Therefore, the attachment hole 21 can be easily formed as compared with the first embodiment in which the attachment hole 21 is inclined with respect to the axis C.

Also, the technical scope of the present invention is not limited to the above-described embodiments, and various modifications can be made without departing from the spirit of the present invention.

For example, although the engagement portions 54 are configured to engage with the stepped portion between the steel plate pieces 20, the present invention is not limited thereto. For example, the attachment hole 21 may be configured to have a recessed portion that is recessed outward in the circumferential direction at a position corresponding to the engagement portion 54, and the engagement portion 54 may engage with this recessed portion.

The support body 5 may have a single leg portion 52 and a single engagement portion 54. The attachment hole 21 may be a single hole.

For example, the pair of engagement portions 54 may be provided to protrude in directions in which the pair of leg portions 52 come closer to each other, and may be inserted into the attachment hole 21 while bending the leg portions 52 in directions in which they are separated from each other. In this case, an innermost width length of the pair of attachment holes 21 is preferably formed to be larger than a length between the pair of engagement portions 54.

The thermistor unit 4 may be attached to a component other than the stator 1, such as a rotor and other mechanical components.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Stator

2 Stator core

3 Coil (measurement target)

4 Thermistor unit

5 Support body

6 Thermistor

21 Attachment hole

51 Main body portion

52 Leg portion

53 Tip

54 Engagement portion

L1 Length between outermost portions

L2 Outermost width length

What is claimed is:

1. A stator comprising:
a stator core which is formed in an annular shape and has an attachment hole recessed in an axial direction thereof;
a coil which is mounted on the stator core and partly protrudes from an end surface of the stator core in the axial direction; and
a thermistor unit which is partly inserted into the attachment hole and fixed to the stator core,
wherein the thermistor unit includes a thermistor measuring a temperature of the coil, and a support body supporting the thermistor,
the support body including:
a main body portion which holds the thermistor to be in contact with the coil;
a leg portion which has elasticity, extends from the main body portion and is inserted into the attachment hole; and
an engagement portion which is provided in the leg portion and engages with the stator core.

2. The stator according to claim 1, wherein the attachment hole is formed to be inclined with respect to a protruding direction of the coil from an inner side toward an outer side in a radial direction of the stator core while going from an inner side toward an outer side in the axial direction.

3. The stator according to claim 1, wherein the engagement portion is provided at a tip of the leg portion.

4. The stator according to any one of claims 1,
wherein a pair of the leg portions are provided side by side,
a pair of the engagement portions are provided to protrude in directions in which the pair of leg portions are separated from each other, and
a length between outermost portions of the pair of engagement portions is larger than an outermost width length of the attachment hole in a circumferential direction of the stator core.

5. The stator according to any one of claims 1, wherein the support body is made of a resin material.

6. A thermistor unit configured to measure a temperature of a measurement target by bringing a thermistor into contact with the measurement target, comprising:
a thermistor measuring the temperature of the measurement target;
a main body portion which holds the thermistor to be in contact with the measurement target;
a leg portion which has elasticity, extends from the main body portion, and is inserted into an attachment hole provided to be inclined with respect to the measurement target; and
an engagement portion which is provided in the leg portion and engages with the attachment hole.

7. The thermistor unit according to claim 6, wherein the engagement portion is provided at a tip of the leg portion.

8. The thermistor unit according to claim 6,
wherein a pair of the leg portions are provided side by side,
a pair of the engagement portions are provided to protrude in directions in which the pair of leg portions are separated from each other, and
a length between outermost portions of the pair of engagement portions is larger than an outermost width length of the attachment hole in an arrangement direction of the leg portions.
